(19) United States
(12) Patent Application Publication
(10) Pub. No.: US 2006/0189470 A1
(43) Pub. Date: Aug. 24, 2006

(54) Lead-free and cadmium-free glass for glazing, enamelling and decorating glasses or glass-ceramics

(76) Inventor: Ina Mitra, Stadecken-Elsheim (DE)

Correspondence Address: HARNESS, DICKEY & PIERCE, P.L.C., P.O. BOX 828, BLOOMFIELD HILLS, MI, 48303, US

(21) Appl. No.: 11/337,903

(22) Filed: Jan. 23, 2006

(30) Foreign Application Priority Data
Jan. 24, 2005 (DE) 10 2005 004 068.3

(51) Int. Cl. C03C 3/089; C03C 3/091; C03C 8/02; B05D 3/02

(52) U.S. Cl. 501/21; 501/65; 501/66; 427/374.1

(57) ABSTRACT

A lead and cadmium free glass for decorating and enamelling glasses or glass-ceramics having a small coefficient of thermal expansion is disclosed comprising the following components (in wt.-%): Σ (Li₂O+Na₂O+K₂O) 0 to 10, Σ (MgO+CaO+SrO)≧0.1, SiO₂>65. Preferably, the glass according to the invention is mixed as a glass frit with pigments, fillers and other additions and applied to glasses or glass-ceramics having a very small thermal expansion. Bending strengths of more than 70 MPa can be reached, in particular when coating substrates made of lithium aluminum silicate glass-ceramics.

### BACKGROUND OF THE INVENTION

The invention relates to a lead-free and cadmium-free glass for glazing, enamelling and decorating glasses or glass-ceramics, to the use of a glass of this type and to a process for glazing, enamelling and decorating glasses or glass-ceramics.

Glasses for glazing, enamelling and decorating glasses or glass-ceramics have been known for thousands of years. However, if they are to be applied to glasses or glass-ceramics with a low coefficient of thermal expansion, for example of less than 2·10⁻⁶/K between 20 and 700° C., special demands are imposed on them. Base materials of this type are customarily used, for example, as thermally stable laboratory apparatus, cookware, fireproof glasses, chimney viewing windows, heatable plates and in particular also as cooking plates.

A glaze or enamel is generally used either to alter the surface properties of the substrate material, for example to coat the substrate to protect it against chemical or physical attack, to assist the component function, for example as a marking, or to decorate the surface. The pigments which may be contained in glaze or enamel increase the covering power and produce a certain color impression. However, the desired color impression can also be achieved by using coloring oxides which are dissolved in the glass and thereby produce a colored glaze.

The firing of the glaze or enamel usually takes place at temperatures which are below the softening range of the substrate material but are sufficiently high to ensure that the glaze is fused on smoothly and intimately joined to the surface of the substrate material.

One possible way of producing glazes consists in melting down the glaze raw materials to form a glass which is milled after it has been melted and cooled. The milled product is referred to as a glass frit. A glass frit of this type is usually mixed with suitable auxiliaries, for example suspending agents, which are then used to apply the glaze/enamel. It can be applied, for example, by screen-printing, transfer, spraying or brushing processes. The generally organic auxiliaries which are required are volatilized as they are fired.

If glasses or glass-ceramics are used in the above mentioned application areas, different demands are consequently imposed on the glaze or enamel. For example, the glaze/enamel must be sufficiently thermally, chemically and physically stable, i.e. must be able in particular to withstand the chemical and physical attacks which are customarily encountered in the laboratory and/or in the domestic sector. In conventional applications, the color impression of the glaze/enamel must not change or must only change very slightly. This leads, inter alia to further demands on the stability of the pigments used.

The durability of glazes and enamels on a substrate material is determined to a significant extent by the formation of stresses; excessively high stresses lead to flaking. These stresses occur inter alia as a result of the differences in thermal expansion properties of enamel and substrate, and consequently, it is very important to adapt the thermal expansion of the decor to the substrate material. In general, the aim is a glaze which has a thermal expansion slightly lower than that of the substrate material. The compressive stresses between glaze and substrate material which are produced after cooling do not then have any adverse effect.

In the case of glasses and glass-ceramics with a very low thermal expansion, which depending on the temperature range may be in the vicinity of zero, it is not generally possible to set the coefficient of thermal expansion of the glaze in this way. Instead, in the case of glasses and glass-ceramics with a very low thermal expansion, this problem is in practice counteracted by applying very thin films, in which case, the glazed glasses which are then used may generally have higher coefficients of thermal expansion than the substrate material. In the case of very thin layers, a relatively great difference in the coefficients of thermal expansion can be tolerated. The sufficient durability of the glazes is in this case attributed to the elasticity of the glaze layer.

For the applied glaze layer to have as little influence as possible on the strength of the substrate material, the aim is layers that are as thin as possible, since a surface layer of this type generally reduces the strength level of the substrate material. However, if the glaze is made extremely thin, it is no longer guaranteed to be sufficiently resistant to the chemical and physical attacks which are customary in the laboratory and/or the domestic sector, or to have an intensive color impression.

In recent times, furthermore, there has been an increase in demand for glazes which are free of toxicologically harmful components, such as lead and cadmium compounds.

Lead-free and cadmium-free glazes of this type are in principle already known, but do not have the required strength when coating glasses and glass-ceramics with very low expansion coefficients.

U.S. Pat. No. 5,326,728 discloses a glass frit for enamelling glass-ceramics with a low thermal expansion, which contains 1 to 3% by weight of Li₂O, 0 to 3% by weight of Na₂O, 2 to 5% by weight of K₂O, 23 to 30% by weight B₂O₃, 10 to 22% by weight of Al₂O₃, 35 to 50% by weight of SiO₂, 0 to 5% by weight of ZrO₂, with the sum content of BaO, CaO, MgO, ZnO, SrO being less than 7% by weight, and with the sum content of alkali metal oxides being less than 8% by weight. A high chemical stability cannot be achieved with the SiO₂ content limited to at most 50% by weight. Also, a glaze of this type does not produce a high strength of decorated object.

EP 0 771 765 A1 discloses a glaze which consists of 30 to 94% by weight of glass frit, 5 to 69% by weight of TiO₂ powder and 0.05 to 34% by weight of pigment. The glass frit contains 0 to 5% by weight of Li₂O, 0 to 10% by weight of Na₂O, 0 to 5% by weight of K₂O, 1 to 10% by weight of BaO, 0.1 to 3% by weight of ZnO, 10 to 30% by weight of B₂O₃, 1 to 10% by weight of Al₂O₃, 45 to 75% by weight of SiO₂ and 0 to 2% by weight of F⁻. The TiO₂ powder which is added to this glaze has to satisfy particular conditions, in particular has to be very finely milled, and entails additional outlay for the entire process of producing the glaze, which should be avoided. On account of the coloring action of the TiO₂ as a white pigment, the use of TiO₂ constitutes a restriction in the possible colors, in particular for dark colors.

EP 0 776 867 A1 discloses a glaze for enamelling glass-ceramic with a low thermal expansion, which in addition to 40 to 98% by weight of glass frit also contains 1 to 55% by weight of pigments and optionally up to 54% by weight of an additional filler. The glass frit consists of 0 to 2% by weight of LiO₂, 5.1 to 15% by weight of Na₂O, 0 to 2.8% by weight of K₂O, 14 to 22% by weight of B₂O₃, 4 to 8% by weight of Al₂O₃, 55 to 72% by weight of SiO₂ and 0 to 2% by weight of F⁻. The filler in this case consists of high-melting ZrO₂ and/or zirconium. The relatively high Na₂O content of from 5.1 to 15% by weight leads to a deterioration in the chemical resistance of the glaze.

Another composition for enamelling glass-ceramics with a low thermal expansion which is known from JP-A 07061837 (Patent Abstracts of Japan) contains 25 to 55% by weight of glass frit, 0.1 to 20% by weight of a refractory filler and 3 to 25% by weight of a thermally stable pigment. The glass frit includes 50 to 75% by weight of SiO₂, 0.5 to 15% by weight of Al₂O₃, 5 to 30% by weight of B₂O₃, 0 to 7% by weight of BaO, 0 to 2% by weight of Li₂O, 0 to 5% by weight of Na₂O, 0 to 4% by weight of K₂O and 0 to 2% by weight of Fe₂O₃. The addition of the high-melting filler means additional processing outlay during the production of the glaze. This also impedes rapid and uniform melting-on of the glaze. The coloration associated with the use of ZrO₂ is often also undesirable.

Furthermore, DE 197 21 737 C1 discloses a lead-free and cadmium-free glass composition for glazing, enamelling and decorating glasses or glass-ceramics with a low thermal expansion. The glass frit contains 0 to 5% by weight of Li₂O, 0 to 5% by weight of Na₂O, less than 2% by weight of K₂O, 0 to 3% by weight of MgO, 0 to 4% by weight of CaO, 0 to 4% by weight of SrO, 0 to 4% by weight of BaO, 0 to 4% by weight of ZnO, 15 to 27% by weight of B₂O₃, 10 to 20% by weight of Al₂O₃, 43 to 58% by weight of SiO₂, 0 to 4% by weight of ZrO₂ and 0 to 3% by weight of F⁻. At relatively low alkali metal contents of up to at most 10% by weight, relatively high levels of glass-forming oxides (64 to 75% by weight), for example 10 to 20% by weight of Al₂O₃ are used, increasing the melting-down temperature of the frit material.

Furthermore, DE 198 34 801 A1 discloses a lead-free and cadmium-free glass composition for glazing, enamelling and decorating glasses or glass-ceramics with a low thermal expansion, which includes 0 to 6% by weight of Li₂O, 0 to 5% by weight of Na₂O, less than 2% by weight of K₂O, an alkali metal oxide content of between 2 and 12% by weight, 0 to 4% by weight of MgO, 0 to 4% by weight of CaO, 0 to 4% by weight of SrO, 0 to 1% by weight of BaO, 0 to 4% by weight of ZnO, 3 to less than 10% by weight of Al₂O₃, 50 to 65% by weight of SiO₂, 0 to 4% by weight of ZrO₂, 0 to 4% by weight of TiO₂ and 0 to 4% by weight of F⁻.

Furthermore, EP 1 119 524 B1 discloses a glaze for enamelling glass-ceramics with a low thermal expansion, such as for example, cooking plates, which contains 70 to 82% by weight of SiO₂, 12 to 18% by weight of B₂O₃, 1 to 3% by weight of Al₂O₃, a sum content of Na₂O and K₂O of at most 5% by weight and 10 to 35% by weight of pigments.

The very high SiO₂ content, which amounts to at least 70% by weight, without suitable additions leads to poor melting-on of the glaze, leading to porous glass structures which are difficult to clean.

Furthermore, FR 2 732 960 A1 discloses a glass frit for enamelling which includes 0 to 2% by weight of Li₂O, 0 to 3% by weight of Na₂O, 0 to 3% by weight of K₂O with a sum alkali metal oxide content of less than 4% by weight, and also contains 0 to 9% by weight of MgO, 0 to 12% by weight of CaO, 0 to 16% by weight of SrO, 0 to 27% by weight of BaO, 0 to 17% by weight of ZnO, 0 to 10% by weight of B₂O₃, 6 to 17% by weight of Al₂O₃, 45 to 60% by weight of SiO₂ and 0 to 7% by weight of ZrO₂. The sum of the alkaline-earth metal oxides is in this case 22 to 42% by weight. The limited alkali metal oxide content can lead to problems with melting-on and result in porous glass structures which are difficult to clean.

Furthermore, EP 1 275 620 A1 discloses a lead-free glaze for enamelling glasses and glass-ceramics, which contains 0 to 7% by weight of Li₂O, 0 to 7% by weight of Na₂O, 0 to 7% by weight of K₂O with a sum alkali metal oxide content of more than 4% by weight, 0 to 12% by weight of CaO, 13 to 27% by weight of BaO, 3 to 17% by weight of ZnO, 0 to 10% by weight of B₂O₃, 6 to 17% by weight of Al₂O₃, 45 to 60% by weight of SiO₂.

DE 42 01 286 A1 discloses another glass composition for glazing, enamelling and decorating glasses or glass-ceramics, which contains 0 to 12% by weight of Li₂O, 0 to 10% by weight of MgO, 3 to 18% by weight of CaO, 5 to 25% by weight of B₂O₃, 3 to 18% by weight of Al₂O₃, 3 to 18% by weight of Na₂O, 3 to 18% by weight of K₂O, 0 to 12% by weight of BaO, 25 to 55% by weight of SiO₂, 0 to 5% by weight of TiO₂ and 0 to <3% by weight of ZrO₂.

All of the abovementioned glass compositions for glazing, enamelling and decorating glasses or glass-ceramics do not have a sufficiently high glaze strength for many applications, in particular if the coated objects have a low coefficient of thermal expansion.

### SUMMARY OF THE INVENTION

In view of this, it is a first object of the invention to disclose a lead-free and cadmium-free glass which is particularly suited for coating or enamelling glass or glass-ceramics products.

It is a second object of the invention to disclose a glass for coating glass or glass-ceramics products which ensures a high strength of the decorated material even when coating glasses or glass-ceramics with a low thermal expansion.

It is a third object of the invention to disclose a glass for coating glass or glass-ceramics products allowing a simple coating procedure while optimizing properties with regard to adhesion, color, constancy, chemical, thermal and abrasive resistance, even if the glass as a frit is provided with an addition of up to 30% by weight of a thermally stable pigment.

These and other objects of the invention are achieved by a lead-free and cadmium-free glass having the features of claim 1. Advantageous refinements are characterized in the dependent claims.

The object of the invention is in this way completely achieved, since the glass according to the invention has a high flexural strength in particular when used to coat glasses or glass-ceramics with a coefficient of thermal expansion of at most 4·10⁻⁶/K in particular of at most 3.5·10⁻⁶/K in particular of at most 2·10⁻⁶/K between 20 and 700° C. In this context, flexural rupture strengths of at least 70 MPa can be achieved on the coated objects.

In a preferred refinement of the invention, the glass according to the invention is milled to form a glass frit, which preferably has a mean particle diameter of at most 10 μm, preferably of less than 6 μm, more preferably of less than 4 μm, particularly preferably of less than 3 μm.

According to another configuration of the invention, the glass frit can be mixed with pigments, fillers and additives, which preferably in total form at most 40% by weight, more preferably in total at most 30% by weight.

The glass according to the invention is composed of the network-forming and if appropriate network-modifying oxides and components for reducing the viscosity and the melting-down temperature.

The network of the glass is mainly formed by the SiO₂ component. The chemical resistance is primarily determined by SiO₂. The high SiO₂ content of more than 65% by weight leads to a chemically very stable glass. The preferred composition range is between >65% by weight and at most 75% by weight of SiO₂, so that the melting-down temperature does not become too high.

The network-modifying alkaline-earth metals and ZnO have favorable effects on the viscosity properties of the glass, but to a lesser extent than when using Alkali metal oxides. High MgO, CaO, SrO and BaO and also ZnO contents lead to a drop in the strength, with the result that the MgO, CaO, SrO and BaO contents are restricted to at most in each case 8% by weight, preferably in each case at most 6% by weight. The ZnO content is preferably restricted to 6% by weight. The sum content of MgO+CaO+SrO+BaO is preferably at most 22% by weight.

A considerable reduction in the viscosity, and therefore good firing of the glaze, is achieved by an addition of B₂O₃ for which purpose, for example, 10% by weight of B₂O₃ can be added. In principle, an addition of B₂O₃ contributes to stabilizing the glass with respect to crystallization. By contrast, at contents of over 22% by weight, the chemical resistance is reduced considerably in this glass system.

Therefore, the preferred range for B₂O₃ is between approximately 6.5 and 35% by weight, in particular between 10 and 20% by weight.

The chemical resistance of the glass is also promoted by additions of Al₂O₃ and if appropriate by additions of TiO₂, ZrO₂ and/or SnO₂. The excessively high contents of these oxides in turn lead to a considerable increase in viscosity both when melting the glass and when firing it onto the substrate material.

It is preferable to add at least 0.1% by weight of Al₂O₃, preferably at least 3% by weight, while the maximum Al₂O₃ content is preferably limited to 10% by weight.

Poor firing properties on account of a high viscosity lead to porous structures, making the glasses difficult to clean. Therefore, the TiO₂ and ZrO₂ contents are preferably limited to in each case 4% by weight and preferably at most 3% by weight.

The reduction in the viscosity and favorable melting properties are achieved by using the alkali metals Li₂O, Na₂O and K₂O, but these components have an adverse effect on the chemical resistance and the strength of the substrate coated with the glass layer. The thermal expansion of the glass is also considerably increased by these components. In this context, the component K₂O has particularly favorable effects on the adhesion, but on the other hand also has the greatest strength-reducing action. Therefore, the contents of these components are preferably restricted to at most 2% by weight of K₂O at most 6% by weight of Li₂O preferably at most 5.8% by weight, and at most 5% by weight of Na₂O.

The meltability can be improved by further additions, such as La₂O₃, Bi₂O₃ and/or P₂O₅. The adhesion can be improved in particular by additions of Sb₂O₃ although excessively high contents lead to a deterioration in the chemical resistance.

Additions of fluorine, which are incorporated in the oxidic glass network as F⁻ ions at anion sites of the oxygen skeleton, act in a similar way. Therefore, the fluorine content is preferably restricted to 4% by weight, in particular to at most 3% by weight.

The maximum proportion of the components SnO₂, Sb₂O₃, La₂O₃, Bi₂O₃ and P₂O₅ is preferably restricted to in each case 3% by weight, and in particular if a plurality of these oxides are used simultaneously, the sum of these oxides is preferably less than 5% by weight.

It is preferable for the glass according to the invention, first of all to be melted and then milled to form a glass frit which has a mean particle diameter of at most 10 μm, preferably of less than 6 μm, more preferably of less than 4 μm, particularly preferably of less than 3 μm.

As has already been mentioned, the milled glass frit can be mixed with pigments, fillers and additives, in which case it is preferable to add a total of at most 40% by weight, more preferably a total of at most 30% by weight.

The glass according to the invention is particularly suitable for glazing, enamelling or decorating glasses or glass-ceramics with a coefficient of thermal expansion of at most 4·10⁻⁶/K, in particular of at most 3.5·10⁻⁶/K. A particularly advantageous use is for glazing lithium aluminosilicate glass-ceramics (LAS), in particular comprising beta-quartz solid solutions as the main crystal phase, which have a coefficient of thermal expansion of less than 2·10⁻⁶/K between 20 and 700° C. Glass-ceramics of this type are used in particular for cooking plates, such as for example the cooking plates produced by the applicant and marketed under the brand Ceran®.

The object of the invention is also achieved by a process for glazing, enamelling or decorating glasses or glass-ceramics in which a glass frit is produced having the composition according to the invention, is processed to a suitable consistency if appropriate with the addition of additives, and is then applied to the surface of a body that is to be coated and fired.

The firing operation in this case preferably takes place between temperatures of approximately 800 and 1200° C. If glass-ceramics which include beta-quartz solid solutions as the main crystal phase are to be enamelled, the firing operation preferably takes place between approximately 800 and 950° C.

The layer thickness of the fired glaze can be set, for example, to between 1 and 5 μm.

The firing operation can be carried out simultaneously with the ceraming of the glass-ceramics.

Alternatively, the firing operation may also be carried out in a separate step following the conclusion of the ceraming of the glass-ceramics.

The softening properties of the glass according to the invention can be set in such a way that at the respective process temperatures it is guaranteed on the one hand to melt on smoothly and on the other hand to have a sufficient durability to maintain the sharpness of the contours of the applied design.

The glass-ceramics or glasses with a low thermal expansion which have been coated with the glasses according to the invention are able to withstand the stresses which usually occur in practice. A good adhesion of the glaze layer is achieved even after long-term exposure to heat, without any change in the color impression, and after frequent temperature change cycles. The demand for good chemical stability is likewise satisfied. Moreover, the glasses according to the invention have further advantageous properties, such as for example low abrasion, insensitivity to spots and resistance to standard domestic cleaning agents.

A particular advantage of the glasses according to the invention consists in the high strength of the substrates coated with the glasses according to the invention. If substrates without added pigment are coated, it is possible to achieve very high strengths of at least 70 MPa.

If pigments are added to the glasses according to the invention (preferably in amounts of up to 30%), experience has shown that the strength level which is established in each case may change. Furthermore, the strength level which is established may change as a function of the surface coverage of the glaze layer on the substrate material. A full-surface glaze generally leads to lower strength properties than a light or sparing pattern formation of the glaze layer. Therefore, if only individual parts of a surface are part-glazed, the strength level indicated for the glaze according to the invention can be shifted to even higher levels.

The glasses according to the invention are processed to form glass frits and, with the addition of generally organic auxiliaries and, if appropriate, colored pigments, are processed to form suitable pastes or the like, which can be applied by screen-printing, transfer, spraying or brushing processes. The generally organic additives required are volatilized during the firing operation.

### EXAMPLES

Table 1 compiles several glasses according to the invention, giving their compositions and the properties determined when used as a glaze.

The associated glasses are melted and used to produce glass frits with mean particle sizes of between 0.8 and 3 μm generally between 1 and 2.5 μm. The pigments used in the examples are commercially available. For application by means of direct screen printing, pastes which are suitable for screen printing were produced by the addition of screen-printing oil.

These pastes were applied to substrates made from lithium aluminosilicate glass-ceramics, which in particular contained beta-quartz solid solutions as the main crystal phase. Compositions of such glass-ceramics can be found, for example, in EP 0 220 333 B1 or DE 199 39 787 C2, which are hereby incorporated by reference.

Glass-ceramics of this type have a very low coefficient of thermal expansion of less than 2·10⁻⁶/K and as the main crystal phase comprise beta-quartz solid solutions, if appropriate with admixed keatite.

In the examples, the decor was applied to a glass before ceramization to a glass-ceramic. The decor firing was carried out simultaneously with the transformation of the substrate glass into a glass-ceramic.

Unless stated otherwise, layer thicknesses of between 2.8 and 3.2 μm were measured after the firing operation.

The adhesion of the decors to the coated glass-ceramic was determined by means of transparent adhesive tape (Tesa-Bild® type 104, Beiersdorf). For this purpose, after the tape had been rubbed on to the decor layer and then suddenly pulled off, it was assessed whether and how many decor particles adhered to the adhesive film. The test was only considered to have been passed if no or only a very small number of particles adhered to the adhesive film.

In all the examples listed, the adhesive strength was in order, i.e. the test was passed.

The flexural strength was determined by the double ring method of DIN 52300, Part 5, on specimens with dimensions of 100×100 mm which were fully coated in the centre with an area of 50×50 mm. The mean strength of at least 24 specimens is given in Table 1.

Table 2 gives a number of compositions and properties of conventional glasses for comparison purposes, which were melted within the composition ranges known from the documents and tested.

It can be seen that for all of the conventional glasses in Table 2 the flexural strength was at most 50 MPa, and in some cases well below this. By contrast, the glasses according to the invention as presented in Table 1 achieved strengths of well above 70 MPa.

TABLE 1
Composition in % by weight and properties of glasses according
to the invention

| | Glass No. | | |
|---|---|---|---|
| | 1 | 2 | 3 |
| Li₂O | 5 | 2 | |
| Na₂O | | 4 | 4 |
| K₂O | | | |
| MgO | 2 | 2 | 2 |
| CaO | 2 | | |
| SrO | 2 | 2 | |
| BaO | | | 2 |
| ZnO | | | |
| B₂O₃ | 13 | 15 | 18 |
| Al₂O₃ | 6 | 5 | 4 |
| SiO₂ | 70 | 70 | 70 |
| ZrO₂ | | | |
| F | | | |
| T_{g}(° C.) | 495 | 508 | 521 |
| E_{w}(° C.) | | 724 | |
| α_{20-300° C.} | 4.1 | 4.76 | 3.76 |
| (10⁻⁶/K) | | | |
| Layer Thickness | 4.1 | 5.0 | |
| (μm) | | | |
| (without added | | | |
| pigment) | | | |
| Flexural | 70.5 | 79 | 80 |
| Strength (MPa) | | | |
| (without added | | | |
| pigment) | | | |
| Flexural | | | 58 |
| Strength with | | | |
| 20% added | | | |
| pigment | | | |
| (white) (MPa) | | | |

TABLE 2
Compositions (in % by weight) and properties of a few conventional
glasses for enamelling, together with properties

| | Glass No. | | | | | | |
|---|---|---|---|---|---|---|---|
| | 4 | 5 | 6 | 7 | 8 | 9 | 10 |
| Li₂O | 2.6 | | | 1.1 | 3.1 | 4.6 | 1 |
| Na₂O | 0.8 | 2.6 | | 9.2 | | 4.1 | 4 |
| K₂O | 3.4 | 1.25 | | 0.4 | | — | |
| MgO | | | | — | | 0.9 | — |
| CaO | 2.8 | | 1 | — | | 1.3 | — |
| SrO | | | | — | 2.3 | 1.8 | — |
| BaO | | | 26.1 | 2.6 | | — | — |
| ZnO | | | 14.5 | — | 2.2 | 0.2 | — |
| B₂O₃ | 27.4 | 14.75 | 4.9 | 19.1 | 16.7 | 17.5 | 21 |
| Al₂O₃ | 18.7 | 2.25 | 6.5 | 5 | 16.6 | 6 | 16 |
| SiO₂ | 41.8 | 78.3 | 47 | 62.4 | 54.3 | 60.3 | 54 |
| TiO₂ | | | | — | | — | 1 |
| ZrO₂ | 2.5 | | | — | 1.1 | 2.1 | 1 |
| As₂O₃ | | 0.85 | | — | | — | — |
| F | | | | 0.2 | | 1.2 | 2 |
| T_{g} (° C.) | 493 | 501 | 655 | 520 | 578 | 475 | 480 |
| E_{w} (° C.) | 680 | 819 | 830 | 670 | 775 | 630 | 745 |
| α_{20-300° C.} | 5.54 | 3.21 | 5.28 | 6.5 | 4.41 | 6.2 | 4.5 |
| (10⁻⁶/K) | | | | | | | |

Glass No.

| | 4 | 5 | 6 | 7 | 8 | 9 |
|---|---|---|---|---|---|---|
| Pigment | — | — | — | — | — | — |
| Addition | | | | | | |
| Flexural | 34 | 66 | 56 | 39 | 42 | 46 |
| Strength | | | | | | |
| (MPa) | | | | | | |
| Pigment | 20% | 20% | 20% | 20% | 20% | 20% |
| Addition | white | white | white | white | white | white |
| Flexural | 33 | 50 | 39 | 38 | 45 | 45 |
| Strength | | | | | | |
| (MPa) | | | | | | |

1. A lead-free and cadmium-free glass for glazing, enamelling or decorating glasses or glass-ceramics, comprising (in % by weight):

| | |
|---|---|
| Li₂O | 0-8 |
| Na₂O | 0-8 |
| K₂O | 0-8 |
| Al₂O₃ | 0-10 |
| B₂O₃ | 6.5-35 |
| MgO | 0.1-12 |
| SrO | 0-16 |
| CaO | 0-12 |
| BaO | 0-13 |
| ZnO | 0-17 |
| SiO₂ | >65-75; |

wherein the sum of alkali metal oxides R₂O is between 0.1 and 10 wt.-%.

2. The glass according to claim 1, comprising at least 2 wt.-% of at least one component selected from the group formed by MgO, CaO, SrO and BaO.

3. The glass according to claim 1, being configured as a coating on an LAS glass-ceramic having a flexural strength, determined by the double ring method, of at least 70 MPa.

4. The glass according to claim 1, comprising 0 to 4 wt.-% of at least one component selected from the group formed by ZrO₂ and TiO₂.

5. The glass according to claim 1, comprising up to 3 wt.-% of fluorine in exchange of oxygen.

6. The glass according to claim 1, comprising 10 to 20 wt.-% of B₂O₃.

7. The glass according to claim 1, comprising 0.1 to 8 wt.-% of Al₂O₃.

8. The glass according to claim 1, further comprising 0.1 to 3% by weight of at least one component selected from the group formed by SnO₂, Sb₂O3, La₂O3, Bi₂O₃ and P₂O₅.

9. The glass according to claim 8, wherein the sum of the components selected from the group formed by SnO₂, Sb₂O₃, La₂O₃, Bi₂O₃ and P₂O₅ is less than 5% by weight.

10. The glass according to claim 1, comprising no more than 8 wt.-% of alkali metal oxides R₂O.

11. A lead-free and cadmium-free glass for glazing, enamelling or decorating glasses or glass-ceramics, comprising (in % by weight):

| | |
|---|---|
| Li₂O | 0-8 |
| Na₂O | 0-8 |
| K₂O | 0-8 |
| B₂O₃ | 6.5-30 |
| MgO | 0.1-12 |
| SrO | 0-16 |
| CaO | 0-12 |
| BaO | 0-13 |
| ZnO | 0-17 |
| SiO₂ | 66-75; |

wherein the sum of the alkali metal oxides is between 0.1 and 8 wt.-%; and
wherein the sum of the components selected from the group formed by MgO, CaO, SrO and BaO is at least 1% by weight.

12. The glass according to claim 11, wherein the sum of the components selected from the group formed by MgO, CaO, SrO and BaO is between 2 and 10% by weight.

13. The glass according to claim 11, wherein the maximum content of each component selected from the group formed by MgO, CaO, SrO and BaO is 7% by weight.

14. The glass according to claim 11, comprising 10 to 20 wt.-% of B₂O₃.

15. The glass according to claim 11, comprising 1 to 8 wt.-% of Al₂O₃.

16. The glass according to claim 12, comprising at least 1% by weight of MgO.

17. The glass according to claim 1, comprising 1 to 8 wt.-% of Al₂O₃.

18. The glass according to claim 11, being configured as a glass frit having a mean particle diameter of at most 3 micrometers.

19. The glass according to claim 18, further comprising up to 30% by weight of at least one component selected from the group formed by pigments, fillers and additives.

20. A method of coating a body consisting a glass-ceramic having a coefficient of thermal expansion of no more than 3·10⁻⁶/K in the temperature range between 20 and 700° C., the method comprising the steps of:
preparing a glass comprising (in % by weight):

| | |
|---|---|
| Li₂O | 0-8 |
| Na₂O | 0-8 |
| K₂O | 0-8 |
| Al₂O₃ | 0-10 |
| B₂O₃ | 6.5-35 |
| MgO | 0.1-12 |
| SrO | 0-16 |
| CaO | 0-12 |
| BaO | 0-13 |
| ZnO | 0-17 |
| SiO₂ | >65-75; |

wherein the sum of alkali metal oxides is between 0.1 and 10 wt.-%;
milling the glass to prepare a glass frit therefrom;
mixing the glass frit with additives to prepare a mixture;
applying the mixture onto a surface of a body to be coated;
firing the body with the applied mixture at a temperature between 800 and 1200° C.; and
cooling the body to room temperature.
